(19) United States
(12) Patent Application Publication
(10) Pub. No.: US 2015/0312690 A1
(43) Pub. Date: Oct. 29, 2015

(54) Audio Processing Apparatus and Audio Processing Method

(71) Applicant: Yamaha Corporation, Hamamatsu-shi (JP)

(72) Inventors: Yuta YUYAMA, Hamamatsu-shi (JP); Masaya KANO, Hamamatsu-shi (JP); Kunihiro KUMAGAI, Hamamatsu-shi (JP)

(21) Appl. No.: 14/693,224

(22) Filed: Apr. 22, 2015

(30) Foreign Application Priority Data
Apr. 23, 2014 (JP) 2014-088869

(51) Int. Cl. H04R 29/00

(52) U.S. Cl. CPC H04R 29/002

(57) ABSTRACT

An audio processing apparatus includes a measuring unit adapted to output a measure-test sound from a plurality of speaker devices and measure an arriving direction of an indirect sound for the output measure-test sound, a generator adapted to generate an adjustment sound for adjusting the indirect sound, and an adjustment sound adder adapted to add the adjustment sound into a sound to be output from at least one of the plurality of speaker devices by a distribution ratio which is set based on the arriving direction of the indirect sound.

### CROSS REFERENCE TO RELATED APPLICATIONS

This application is based upon and claims the benefit of priority of Japanese Patent Application No. 2014-088869 filed on Apr. 23, 2014, the contents of which are incorporated herein by reference in its entirety.

### BACKGROUND OF THE INVENTION

1. Field of the Invention

The present invention relates to an audio processing apparatus and an audio processing method for generating a desired sound field by outputting sounds from a plurality of speaker devices.

2. Description of the Related Art

In a related art, an audio processing apparatus, which generates a sound field by giving a sound field effect to content sounds, has been proposed (for example, refer to JP-A-2001-186599). The sound field effect allows a listener to feel a presence in a different space, such as an actual concert hall, while the listener is present in a room by outputting pseudo reflection sounds which are acquired by simulating reflection sounds which are generated in an acoustic space such as the concert hall.

The audio processing apparatus disclosed in JP-A-2001-186599 delays, for example, an audio signal of a center channel, distributes the delayed audio signal to front right and left speaker devices and a center speaker device, and generates the sound source of the simulated reflection sounds in a position which is different from the actual position where the speaker devices exist, thereby generating the sound field.

### SUMMARY OF THE INVENTION

However, the audio processing apparatus disclosed in JP-A-2001-186599 does not take an indirect sound in a listening environment into consideration. That is, in the listening environment in which a sound is reflected in a ceiling, a wall, or the like, an indirect sound (for example, an initial reflection sound), which is reflected in the ceiling, the wall, or the like and then arrives in a listening position, affects the sound field separately from a direct sound which directly arrives in the listening position from a speaker device. There is a case in which it is difficult for the audio processing apparatus disclosed in JP-A-2001-186599 to make the listening environment have a desired sound field because the indirect sound is generated.

Here, a non-limited object of the present invention is to provide an audio processing apparatus and an audio processing method which can generate a desired sound field in a listening environment in which an indirect sound is generated.

An audio processing apparatus according to an aspect of the present invention includes: a measuring unit adapted to output a measure-test sound from a plurality of speaker devices and measure an arriving direction of an indirect sound for the output measure-test sound; a generator adapted to generate an adjustment sound for adjusting the indirect sound; and an adjustment sound adder adapted to add the adjustment sound into a sound to be output from at least one of the plurality of speaker devices by a distribution ratio which is set based on the arriving direction of the indirect sound.

An audio processing method according to another aspect of the present invention includes: outputting a measure-test sound from a plurality of speaker devices; measuring an arriving direction of an indirect sound for the output measure-test sound; generating an adjustment sound for adjusting the indirect sound; and adding the adjustment sound into a sound to be output from at least one of the plurality of speaker devices by a distribution ratio which is set based on the arriving direction of the indirect sound.

An indirect sound indicates a sound other than a direct sound which directly arrives in a listening position from speaker devices, and indicates a sound (for example, an initial reflection sound) which is reflected in a ceiling, a wall, or the like and then arrives in the listening position. A measurement unit measures the indirect sound including an arrival direction, a level relative to the direct sound, and a delay time relative to the direct sound using, for example, a closely located four point microphone method. In the closely located four point microphone method, four non-directional microphones, which are closely arranged to each other and are not arranged on the same plane, are used. Further, in the closely located four point microphone method, the arrival direction of the indirect sound is measured based on an impulse response which is included in an audio signal collected by the respective non-directional microphones. However, in the present invention, the measurement unit may measure at least the arrival direction of the indirect sound without measuring the delay time and the level. In addition, the measurement unit is not limited to stereoscopically measure the arrival direction of the indirect sound using the closely located four point microphone method, and may only measure the arrival direction of the indirect sound on the horizontal surface which passes through the listening position.

An adjustment sound may be formed of, for example, the same component as the indirect sound. For example, when the right and the left speaker devices are arranged on the front surface of the audio processing apparatus in the listening position and the arrival direction of the indirect sound is a front direction, an adjustment sound adder distributes an adjustment sound to the right and the left speaker devices at a distribution ratio of 1:1. Then, the arrival direction of the adjustment sound coincides with the arrival direction of the indirect sound.

The audio processing apparatus according to the aspect of the present invention can strengthen or weaken the indirect sound by causing the adjustment sound to arrive from the same direction as the arrival direction of the indirect sound. In addition, the audio processing apparatus according to the present invention can widen the sound image of the indirect sound by causing the adjustment sound to arrive from a direction which is slightly deviated from the arrival direction of the indirect sound. As described above, the audio processing apparatus according to the present invention adjusts the indirect sound using the adjustment sound based on the arrival direction of the indirect sound even when the audio processing apparatus according to the present invention is installed in the listening environment in which the indirect sound is generated, and thus it is possible to generate a desired sound field.

The audio processing apparatus may be configured so that the measuring unit is adapted to measure a delay time and a level of the indirect sound relative to a direct sound of the measure-test sound, and the generator is adapted to generate the adjustment sound based on the delay time and the level of the indirect sound measured by the measuring unit.

In this aspect, the adjustment sound is generated by taking the delay time and the level of the indirect sound into consideration. The delay time of the indirect sound corresponds to the distance between the sound source position and the listening position of the indirect sound. Accordingly, for example, the audio processing apparatus can generate the adjustment sound in the same position as the sound source position of the indirect sound at the same level as the indirect sound. Therefore, the adjustment effect of the adjustment sound further increases.

In addition, the generator may generate the adjustment sound including a sound having a reversed phase of the indirect sound. Therefore, the indirect sound is canceled by the adjustment sound. As a result, the audio processing apparatus can cause the listener to feel that the listener is present in an anechoic chamber where the indirect sound is not generated.

The audio processing apparatus may further includes a sound field effect giving unit adapted to give a simulated reflection sound into the sound to be output from at least one of the plurality of speaker devices to apply a sound field effect, and the sound field effect giving unit may be adapted to attenuate a level of the simulated reflection sound based on the level of the indirect sound when a sound source position of the simulated reflection sound coincides with any one of sound source positions of indirect sounds for the measure-test sound.

For example, the sound field effect giving unit generates a simulated reflection sound based on the impulse response which is measured in the concert hall, and outputs the simulated reflection sound from the plurality of speaker devices. In the aspect, the sound field effect giving unit attenuates the level of the simulated reflection sound when the sound source position of the indirect sound almost coincides with the sound source position of the simulated reflection sound, and thus it is possible to prevent the level of the simulated reflection sound from increasing due to the indirect sound in the listening position.

In the audio processing apparatus, the generator may generate the adjustment sound only for the indirect sound of which the delay time is shorter than a prescribed time relative to the direct sound or generate the adjustment sound only fir the indirect sound of which the level is equal to or higher than a prescribed level relative to the direct sound.

In the aspect, the generator generates the adjustment sound only for the indirect sound which is easily perceived by the listener and which easily affects the sound field. Accordingly in the configuration, the increase in the total processing load of the audio processing apparatus is prevented.

In addition, the generator may generate the adjustment sound using a so-called Finite Impulse Response (FIR) filter, but it is preferably optional that the generator includes a multi-tap delay.

In the multi-tap delay, the delay amount of each of the taps is variably set based on the delay time of the indirect sound. Since the generator includes the multi-tap delay, it is preferable that the generator includes taps corresponding to the number of indirect sounds compared to the FIR filter which delays the audio signal only by the delay amount which is fixed to each of the taps, and thus it is possible to generate the adjustment sound using a smaller number of taps.

When the audio processing apparatus according to the present invention is installed in the listening environment in which an indirect sound is generated, the audio processing apparatus according to the present invention adjusts the indirect sound using an adjustment sound based on the arrival direction of the indirect sound, and thus it is possible to generate a desired sound field.

### BRIEF DESCRIPTION OF THE DRAWINGS

In the accompanying drawings:

FIG. 1A is a block diagram illustrating a part of the configuration of an audio system according to a first embodiment;

FIG. 1B is a schematic diagram illustrating a listening environment in a plan view;

FIG. 2 is a block diagram illustrating the function of an AV receiver;

FIG. 3 is a plan schematic diagram illustrating the listening environment to describe measurement of an indirect sound;

FIG. 4A is a schematic diagram illustrating arrival directions, delay times for a direct sound, and levels for the direct sound with regard to a plurality of measured indirect sounds;

FIG. 4B is a schematic graph illustrating impulse responses which include the plurality of measured indirect sounds;

FIG. 5 is a block diagram illustrating a part of the configuration of an adjustment unit;

FIG. 6 is a plan schematic diagram illustrating the listening environment to describe an example in which an adjustment sound is distributed at a distribution ratio based on the arrival direction of an indirect sound;

FIG. 7A is a schematic graph illustrating impulse responses in the listening position before the adjustment sound is added;

FIG. 7B is a schematic graph illustrating the impulse responses in the listening position after the adjustment sound is added;

FIG. 8 is a plan schematic diagram illustrating the listening environment to describe an example in which the sound source position of an indirect sound moves due to the adjustment sound;

FIG. 9 is a block diagram illustrating the function of an AV receiver according to a second embodiment; and

FIG. 10 is a plan schematic diagram illustrating the listening environment to show the respective positions of a simulated reflection sound and an indirect sound.

### DETAILED DESCRIPTION OF THE EXEMPLARY EMBODIMENTS

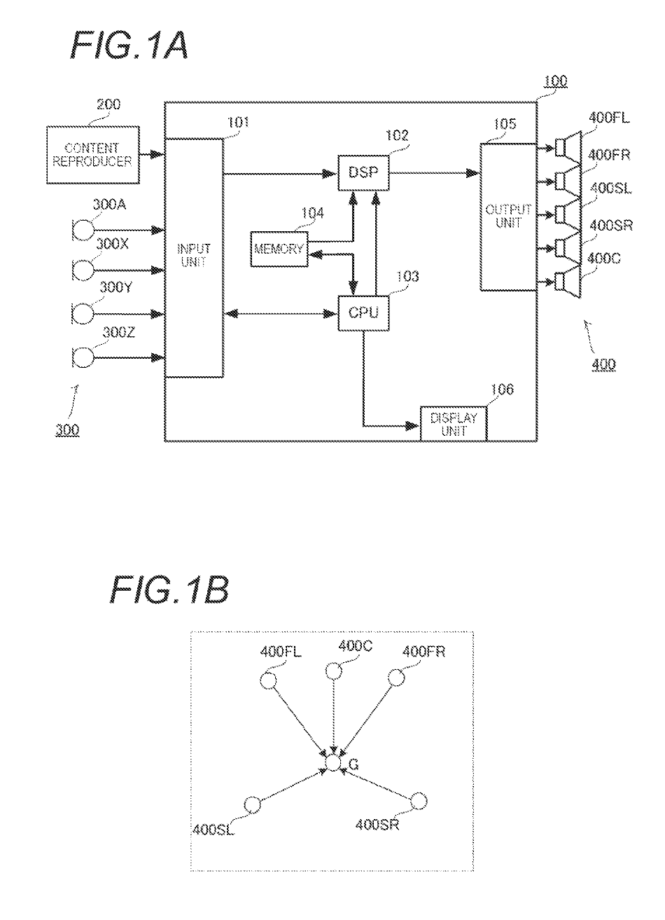

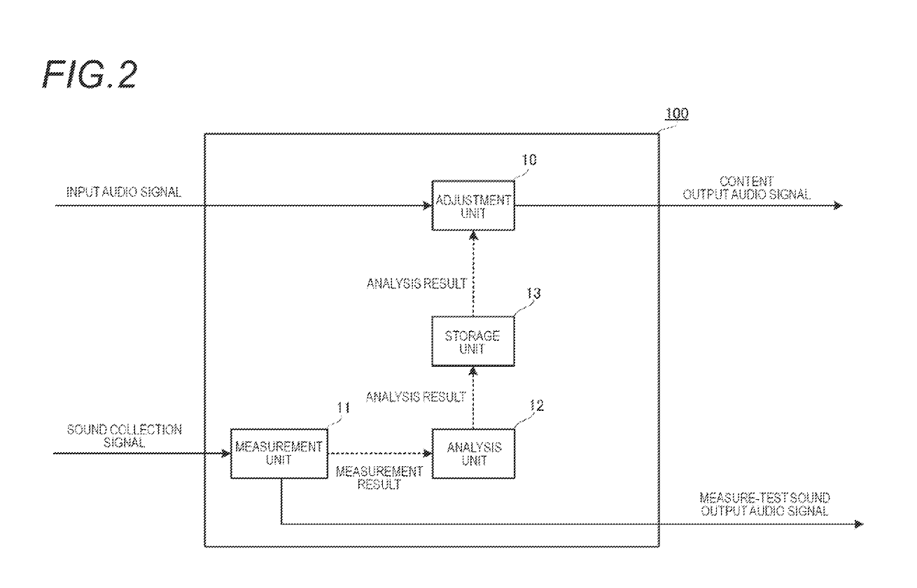

FIG. 1A is a block diagram illustrating a part of the configuration of an audio system according to a first embodiment, and FIG. 1B is a schematic diagram illustrating a listening environment in a plan view. FIG. 2 is a block diagram illustrating the function of an AV receiver. Meanwhile, in FIG. 2, the path of an audio signal is indicated by a solid line and the paths of analysis result information and measurement information are indicated by dotted lines.

The audio system according to the first embodiment generates a desired sound field by outputting an adjustment sound to an indirect sound, which is generated in the listening environment, based on an arrival direction of the indirect sound. The indirect sound indicates a sound (for example, initial reflection sound) which is output from a speaker device, and reflected in, for example, a ceiling, a wall, or the like, and then arrives in a listening position.

As illustrated in FIG. 1A, the audio system includes an AV receiver 100, a content reproducer 200, a plurality of microphones 300 (a microphone 300A, a microphone 300X, a microphone 300Y, and a microphone 300Z), and a plurality of speaker devices 400 (a speaker device 400FL, a speaker device 400FR, a speaker device 400G, a speaker device 400SL, and a speaker device 400SR). The AV receiver 100 corresponds to an audio processing apparatus according to the present invention.

As illustrated in FIG. 1B, the plurality of speaker devices 400 are installed in the vicinity of a listening position G in the listening environment. The example indicates a state in which the speaker device 400C is installed in the front of the listening position G (hereinafter, it is assumed that the front of the listening position G is an orientation of 0° and a positive angle is made through clockwise rotation), the speaker device 400FR is installed on the right front side of the listening position G (an orientation of 30°), the speaker device 400SR is installed on the right rear side of the listening position G (an orientation of 120°), the speaker device 400SL is installed on the left rear side of the listening position G (an orientation of 240°), and the speaker device 400FL is installed on the left front side of the listening position G (an orientation of 330°). However, in addition to the plurality of speaker devices 400, the audio system according to the first embodiment may further include other speaker devices on the upper or lower side of a horizontal plane which passes through the listening position G.

The plurality of microphones 300 are approximately non-directional (or omnidirectional) microphones, respectively. The plurality of microphones 300 are closely arranged to each other in order to measure an indirect sound, which arrives in the listening position G, and are not arranged on the same plane. More specifically, taking the reference as the microphone 300A, the microphone 300X is separately arranged at an orientation of 90° by a distance d, the microphone 300Y is separately arranged at an orientation of 0° by the distance d, and the microphone 300Z is separately arranged vertically upward by the distance d.

The AV receiver 100 includes an input unit 101, a DSP 102, a CPU 103, a memory 104, an output unit 105, and a display unit 106.

The input unit 101 receives content data from the content reproducer 200, and outputs an audio signal, which is extracted from the content data, to the DSP 102. In addition, respective sound collection signals from the plurality of microphones 300 are input to the input unit 101.

The memory 104 stores the analysis result information which will be described later. The memory 104 also stores a program. The program is read and executed by the CPU 103. Therefore, the CPU 103 controls the input unit 101, the DSP 102, the output unit 105, and the display unit 106.

The output unit 105 amplifies each input audio signal, and outputs the amplified audio signal to the speaker device 400FL, the speaker device 400SL, the speaker device 400C, the speaker device 400SR, and the speaker device 400FR.

The display unit 106 performs display based on the analysis result information, which is stored in the memory 104, under the control of the CPU 103. However, the display unit 106 is not an essential component of the embodiment.

The DSP 102 realizes together with the CPU 103 the respective functions of a generator and an adjustment sound adder according to the present invention, and performs a prescribed process on each audio signal, which is input from the input unit 101, according to the control of the CPU 103. In the embodiment, a case in which an indirect sound generated in the listening environment is adjusted by adding an adjustment sound to a content sound will be described.

As illustrated in FIG. 2, the AV receiver 100 realizes the respective functions of an adjustment unit 10, a measurement unit 11, an analysis unit 12, and a storage unit 13. The measurement unit 11 and the analysis unit 12 acquire arrival directions of a plurality of indirect sounds which arrive in the listening position G, delay times of the indirect sounds relative to a direct sound, and levels of the indirect sounds relative to the direct sound with using a closely located four point microphone method in which the plurality of microphones 300 closely arranged to each other are used. The analysis result information acquired by the analysis unit 12 includes information which indicates the arrival direction, the delay time and the level with regard to each of the indirect sounds for each channel. The analysis result information is stored in the storage unit 13 (memory 104).

The measurement unit 11 outputs the audio signal of a measure-test sound for each channel. Each speaker device 400 emits sounds based on the output audio signal of the measure-test sound. Then, each sound collection signal is input to the measurement unit 11 from each of the microphones 300. The measurement unit 11 outputs information (level for elapsed time), which indicates an impulse response for each input sound collection signal, to the analysis unit 12 as the measurement information. That is, the measurement unit 11 outputs information, which indicates four impulse responses corresponding to the four microphones 300, to the analysis unit 12 as the measurement information. The impulse responses indicate a direct sound and the plurality of indirect sounds which arrive in the listening position G. The analysis unit 12 uses a timing, in which a response at a level which is equal to or greater than a prescribed level is detected from among the respective impulse responses, for analysis below as a detection timing of the direct sound and each of the indirect sounds.

The analysis unit 12 acquires the arrival directions of the plurality of indirect sounds, the delay times of the indirect sounds relative the direct sound, and the levels of the indirect sounds relative to the direct sound based on the input measurement information. The analysis unit 12 acquires the sound source position (Xₙ, Yₙ, Zₙ) of an indirect sound n using Equations below based on the Pythagorean theorem in order to acquire the arrival direction of an n-th generated indirect sound n after the direct sound is generated. Meanwhile, it is assumed that an X axis is along an orientation of 90°, a Y axis is along an orientation of 0°, and a Z axis is along a vertical line which passes through the listening position G.

Xₙ=(d²+r²_{A}_{_{—}}ₙ—r²_{X}_{_{—}}ₙ)/2d

Yₙ=(d²+r²_{A}_{_{—}}ₙ—r²_{Y}_{_{—}}ₙ)/d

Zₙ=(d²+r²_{A}_{_{—}}ₙ—r²_{Z}_{_{—}}ₙ)/2d

where, the distance d is a distance between respective microphones 300 as described above. In addition, a distance r_{A}_{_{—}}ₙ is the distance between the sound source position of the indirect sound n and the position of the microphone 300A, and is acquired based on a time and the speed of sound from a timing in which a measure-test sound is output in an impulse response corresponding to the microphone 300A to a timing in which the indirect sound n is detected. In the same manner, a distance r_{X}_{_{—}}ₙ is the distance between the sound source position of the indirect sound n and the position of the microphone 300X, a distance r_{Y}_{_{—}}ₙ is the distance between the sound source position of the indirect sound n and the position of the microphone 300Y, and a distance r_{Z}_{_{—}}ₙ is the distance between the sound source position of the indirect sound n and the position of the microphone 300Z.

The analysis unit 12 acquires the sound source positions (Xₙ, Yₙ, Zₙ) for the respective indirect sounds n. Therefore, the arrival directions of the indirect sounds n are acquired based on the sound source positions (Xₙ, Yₙ, Zₙ) and the listening position G (the position of the microphone 300A). The analysis unit 12 acquires a time from a timing, in which the direct sound is detected in the impulse response corresponding to the microphone 300A, to a timing, in which the indirect sound n is detected, as the delay time of the indirect sound n. In addition, analysis unit 12 acquires a level indicated by each of the impulse responses as the level of the indirect sound n (a ratio of the indirect sound to the level of the direct sound).

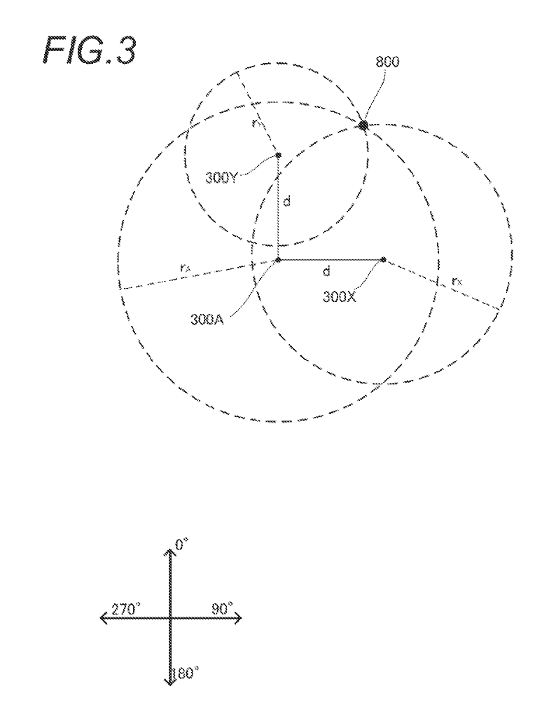

An example of a process performed by the measurement unit 11 and the analysis unit 12 will be described with reference to FIG. 3. FIG. 3 is a plan schematic diagram illustrating the listening environment in order to describe the measurement of an indirect sound. FIG. 3 illustrates an example, in which the sound source position of an indirect sound is acquired on the horizontal plane on which the microphone 300A, the microphone 300X, and the microphone 300Y are arranged, for description. In addition, in the example illustrated in FIG. 3, description will be made while it is assumed that only one indirect sound is generated.

First, the measurement unit 11 outputs the audio signal of a measure-test sound having, for example, a sine wave of 100 Hz to a center channel C. Then, a direct sound from the speaker device 400C and an indirect sound reflected in a ceiling, a wall, or the like, are collected by the microphone 300A, the microphone 300X, and the microphone 300Y. Therefore, the measurement unit 11 acquires information, which indicates impulse responses for the respective sound collection signals, as the measurement information.

In FIG. 3, each dashed line indicates a circle centering at the position of each microphone 300. The radius of each circle is the distance between the sound source position of each indirect sound and the position of the microphone 300, and is acquired based on the time from the timing, in which the direct sound is detected, to the timing, in which the indirect sound is detected, and the speed of sound as described above. Accordingly, FIG. 3 illustrates that the sound source of the indirect sound is positioned on a line segment of the circles. As illustrated in FIG. 3, a circle which has a radius r_{A} centering at the microphone 300A, a circle which has a radius r_{X} centering at the microphone 300X, and a circle which has a radius r_{Y} centering at the microphone 300Y intersect each other at a point 800. That is, it is understood that the sound source position of the indirect sound exists in a position indicated by the point 800. The analysis unit 12 acquires the position of the indirect sound (position indicated by the point 800) for the sound of the center channel (sound output from the speaker device 400C) using the Pythagorean theorem, as described above. Therefore, the arrival direction of the indirect sound is acquired based on the sound source position of the indirect sound and the position of the microphone 300A.

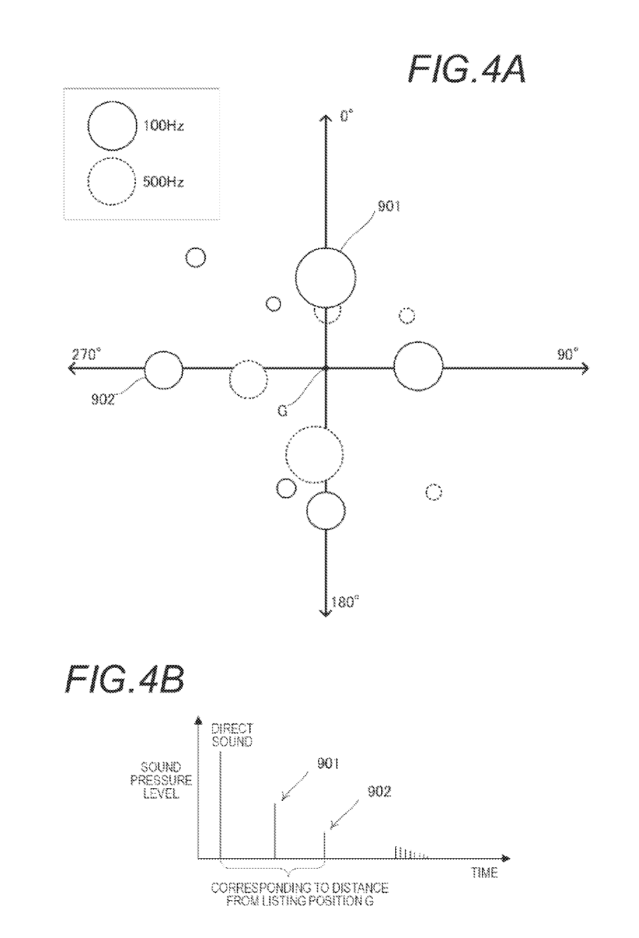

Subsequently the analysis result information acquired by the analysis unit 12 will be described. FIG. 4A is a schematic diagram illustrating arrival directions of a plurality of measured indirect sounds, delay times of the indirect sounds relative to the direct sound, and levels of the indirect sounds relative to the direct sound, and FIG. 4B is a schematic graph illustrating impulse responses which include the plurality of measured indirect sounds. In FIG. 4A, the respective center positions of circles indicate the respective sound source positions of the indirect sounds, the respective radiuses of the circles indicate the respective levels of the indirect sounds, and the distances between the respective center positions of the circles and the listening position G (the position of the microphone 300) indicate the respective delay times of the indirect sounds. In addition, as illustrated in FIG. 4A, the audio system according to the first embodiment outputs, for example, the measure-test sounds of sine waves which have different frequencies, and thus it is possible to acquire the arrival directions, the delay times and the levels of the indirect sounds for each frequency, and to include the arrival directions, the delay times, and the levels of the indirect sounds in the analysis result information.

The audio system outputs, for example, a measure-test sound, which includes a sine wave having a frequency of 100 Hz, from the speaker device 400C. Then, as illustrated in FIG. 4A, an indirect sound 901 for the measure-test sound arrives from an orientation of approximately 0°, and an indirect sound 902 for the measure-test sound arrives from an orientation of approximately 270°. In addition, as illustrated in FIG. 4A, the indirect sound 901 has a sound source position which is close to the listening position G compared to the indirect sound 902, that is, the indirect sound 901 has a delay time which is short compared to the indirect sound 902. In addition, the indirect sound 901 has a level which is high compared to the indirect sound 902. Accordingly, the indirect sound 901 strongly affects the sound field of the listening environment 900 compared to the indirect sound 902. The CPU 102 may display the analysis result information illustrated in FIG. 4A on the display unit 106 in order to show the analysis result information to a listener. Meanwhile, as described above, the levels and the delay times of the indirect sound 901 and the indirect sound 902 are acquired from the impulse responses illustrated in FIG. 4B.

Irrespective of the center channel, the measurement unit 11 and the analysis unit 12 may output measure-test sounds for respective other channels from the speaker devices 400 corresponding to relevant channels, and may acquire the arrival directions, the delay times, and the levels of the indirect sounds for the respective channels as the analysis result information.

In addition, the measurement unit 11 and the analysis unit 12 may stereoscopically acquire the arrival directions of the indirect sounds using the sound collection signal from the microphone 300Z which is vertically arranged from the microphone 300A.

Further, the present invention is not limited to the example in which the measurement unit 11 and the analysis unit 12 simultaneously collect the measure-test sounds using the microphone 300A, the microphone 300X, and. the microphone 300Y. The measurement unit 11 and the analysis unit 12 may acquire the arrival directions or the like of the indirect sounds by moving a single microphone 300 to the respective positions and sequentially collecting the sounds. When the sounds are sequentially collected, it is possible to acquire the arrival directions or the like of the indirect sounds using the single microphone 300.

Returning to the description with reference to FIG. 2, the analysis result information acquired by the analysis unit 12 is stored in the storage unit 13 (memory 104). The adjustment unit 10 reads the analysis result information from the storage unit 13, and adds the audio signal of an adjustment sound for adjusting the indirect sounds to the input audio signal.

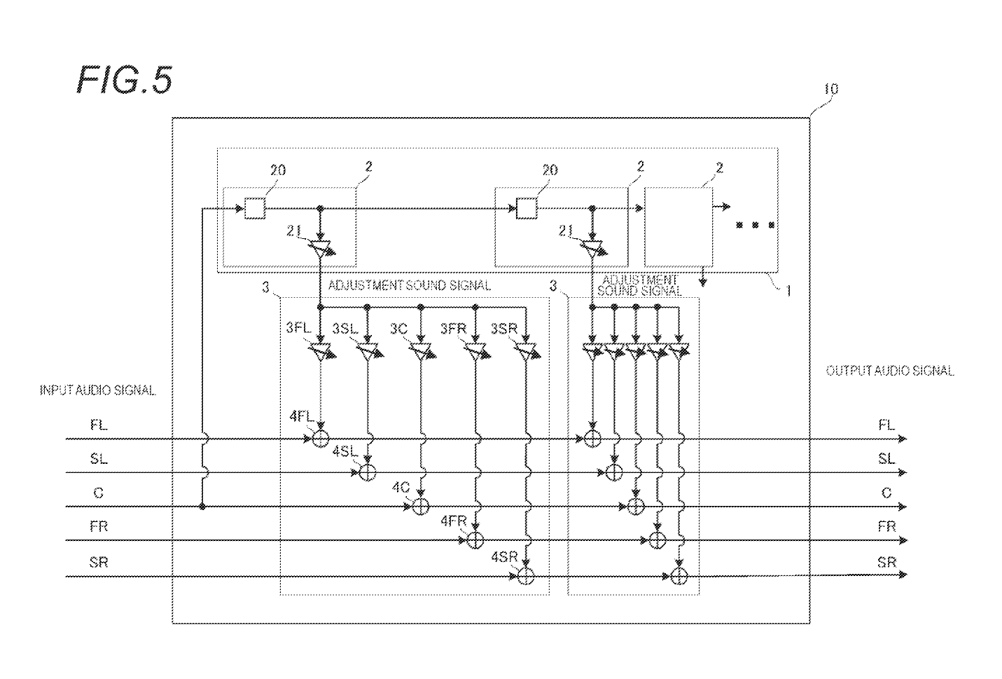

FIG. 5 is a block diagram illustrating the configuration of the adjustment unit. Here, the block diagram of the adjustment unit 10 in FIG. 5 illustrates an example of a configuration in order to add an adjustment sound to each of the indirect sounds with regard to the center channel C. In addition, hereinafter, an example in which each adjustment sound signal is generated in order to cancel each of the indirect sounds of the center channel will be described. However, the adjustment sound signal is not limited to a signal for canceling indirect sounds and may be a signal for strengthening the indirect sounds. The adjustment unit 10 may function as a generator to generate an adjustment sound for adjusting an indirect sound and as an adjustment sound adder to add the adjustment sound into an output sound by a distribution ratio which is set based on the arriving direction of the indirect sound.

As illustrated in FIG. 5, the adjustment unit 10 includes a multi-tap delay 1 and a plurality of distribution units 3.

The multi-tap delay 1 includes a plurality of (for example, 10) taps 2 which are connected in series. Each of the taps 2 includes a delaying unit 20 and a level adjustment unit 21. The delaying unit 20 delays an input audio signal by a prescribed delay amount and outputs a delayed audio signal. The delayed audio signal is output to the level adjustment unit 21 and the delaying unit 20 of a tap 2 at a subsequent stage. The level adjustment unit 21 adjusts the level of the input audio signal, and outputs a level-adjusted audio signal as the adjustment sound signal to a distribution unit 3 corresponding to the tap 2.

The delay amount of the delaying unit 20 of each of the taps 2 is set based on the delay times of the indirect sounds of the analysis result information. The gain of the level adjustment unit 21 of each of the taps 2 is set based on the levels of the indirect sounds of the analysis result information.

The set values of the delay amount of the delaying unit 20 and the gain of the level adjustment unit 21 of each of the taps 2 will be described using a subsequent example. For example, it is assumed that the analysis result information includes information about the delay time and the level of a first indirect sound and a second indirect sound. The first indirect sound is generated after 10 msec from the direct sound, and has 0.5 times higher level than a direct sound. The second indirect sound is generated 30 msec after the direct sound (that is, 20 msec after the first indirect sound), and has 0.3 times higher level than the direct sound. In the example, the delaying unit 20 of a first stage tap 2 is set to a delay time of 10 msec (or the number of samples corresponding to 10 msec), and the level adjustment unit 21 of the first stage tap 2 is set to a gain of −6.0 dB. The delaying unit 20 of a second stage tap 2 is set to a delay time of 20 msec (or the number of samples corresponding to 20 msec), and the level adjustment unit 21 of the second stage tap 2 is set to a gain of −10.0 dB.

Therefore, an adjustment sound signal, which is output from the level adjustment unit 21 of the first stage tap 2, has the same feature amount (the delay time and the level) as the first indirect sound. An adjustment sound signal, which is output from the level adjustment unit 21 of the second stage tap 2, has the same feature amount as the second indirect sound. The respective taps 2 output the adjustment sound signals to the relevant distribution units 3.

The adjustment unit 10 may include a so-called Finite Impulse Response (FIR) filter instead of the multi-tap delay 1 as a component which generates the adjustment sound signals. That is, the adjustment unit 10 may use the FIR filter in which a fixed delay amount (for example, a delay time of 0.02 msec corresponding to a sampling frequency of 48 kHz) is set to the delaying unit of each of the taps instead of the multi-tap delay 1. However, in the FIR filter, the delay amount of the delaying unit is fixed, and thus, for example, 150,000 taps are necessary to generate adjustment sounds corresponding to the indirect sounds, which are generated after 3 sec from when the direct sound is generated. However, as described above, the multi-tap delay 1 variably sets the delay amount of the delaying unit 20 of each of the taps 2, with the result that the taps 2 for only the number of indirect sounds (for example, 10) may be provided, and thus it is possible to generate adjustment sounds corresponding to the indirect sounds using a small number of taps compared to the FIR filter.

Each of the distribution units 3 distributes the input adjustment sound signal to each of the channels at a prescribed distribution ratio. The adjustment sound signal, which is distributed to each of the channels, is synthesized with each of the audio signals which are input to the adjustment unit 10. That is, the adjustment unit 10 distributes an adjustment sound and adds the adjustment sound to the content sound.

More specifically, each of the distribution units 3 includes a level adjustment unit 3FL, a level adjustment unit 3FR, a level adjustment unit 3C, a level adjustment unit 3SL, a level adjustment unit 3SR, a synthesizing unit 4FL, a synthesizing unit 4FR, a synthesizing unit 4C, a synthesizing unit 4SL, and a synthesizing unit 4SR. The adjustment sound signal, which is output from each of the taps 2, is input to the level adjustment unit 3FL, the level adjustment unit 3FR, the level adjustment unit 3C, the level adjustment unit 3SL, and the level adjustment unit 3SR of the relevant distribution unit 3. The adjustment sound signal, which is input to the level adjustment unit 3FL, is synthesized with the audio signal of a channel FL, which is input to the adjustment unit 10, by the synthesizing unit 4FL after the level thereof is adjusted. In the same manner, with regard to a channel FR, the channel C, a channel SL and a channel SR, the adjustment sound signal is synthesized with the audio signal, which is input to the relevant channel, after the level thereof is adjusted for each channel. Further, each of the plurality of speaker devices 400 emits sounds based on the audio signal of the content, with which the distribution components of the adjustment sound signal are synthesized.

Each of the distribution units 3 distributes the adjustment sound signal to the audio signals of the respective channels at the prescribed distribution ratio by setting the gains of the level adjustment unit 3FL, the level adjustment unit 3FR, the level adjustment unit 3C, the level adjustment unit 3SL, and the level adjustment unit 3SR (based on the amplification ratio of amplitude). The distribution ratio is set based on the arrival directions of the indirect sounds which are included in the analysis result information.

The synthesizing unit 4FL, the synthesizing unit 4FR, the synthesizing unit 4C, the synthesizing unit 4SL and the synthesizing unit 4SR reverse the phase of the distributed adjustment sound signal, and synthesize the adjustment sound signal having the reversed phase with the audio signals, which are input to the adjustment unit 10, respectively. However, the synthesizing unit 4FL, the synthesizing unit 4FR, the synthesizing unit 4C, the synthesizing unit 4SL, and the synthesizing unit 4SR synthesize the distributed adjustment sound signal with the audio signals, which are input to the adjustment unit 10, respectively, without reversing the phase of the distributed adjustment sound signal other than in a case in which the indirect sounds are cancelled (for example, a case in which the indirect sounds are strengthened).

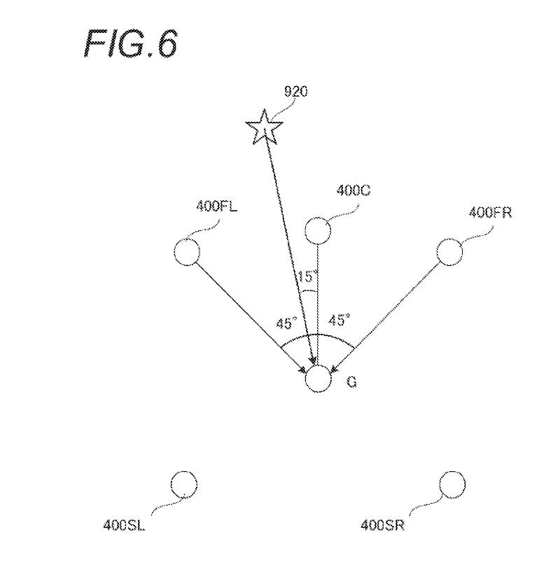

An example of the distribution of an adjustment sound signal will be described with reference to FIG. 6. FIG. 6 is a plan schematic diagram illustrating the listening environment in order to describe the example of the distribution of the adjustment sound signal at a distribution ratio based on the arrival direction of an indirect sound.

In FIG. 6, an indirect sound 920 arrives counter clockwise from an orientation of 15° when the front direction of the listening position G is set to 0°. The adjustment unit 10 first localizes an adjustment sound signal n (which has the same feature amount as the indirect sound 920) in the same direction as the arrival direction of the indirect sound 920 in order to cancel the indirect sound 920. In the example illustrated in FIG. 6, the adjustment unit 10 localizes the adjustment sound signal n using the speaker device 400FL and the speaker device 400FR which are disposed across the arrival direction of the indirect sound 920 and are adjacent to the arrival direction of the indirect sound 920. Accordingly, the adjustment sound signal n, which is input to the distribution unit 3, is not distributed to the speaker device 400C, the speaker device 400SL, and the speaker device 400SR.

In order to localize the adjustment sound signal n in the same direction as that of the indirect sound 920, the distribution ratio (amplification ratio Wₙ_{_{—}}_{FL}:amplification ratio Wₙ_{_{—}}_{FR}) is set by acquiring the amplification ratio Wₙ_{_{—}}_{FL} of the level adjustment unit 3FL and the amplification ratio Wₙ_{_{—}}_{FR} of the level adjustment unit 3FR of the distribution unit 3 corresponding to the adjustment sound signal n using Equation below.

SIN(15°)/SIN(45°)=(Wₙ_{_{—}}_{L}−Wₙ_{_{—}}_{R})/(Wₙ_{_{—}}_{L}+Wₙ_{_{—}}_{R})

where, Wₙ_{_{—}}_{FL}+Wₙ_{_{—}}_{FR}=1

Therefore, an amplification ratio Wₙ_{_{—}}_{FL} of 0.59 and an amplification ratio Wₙ_{_{—}}_{FR} of 0.41 are acquired. That is, the distribution ratio (amplification ratio Wₙ_{_{—}}_{FL}:amplification ratio Wₙ_{_{—}}_{FR}) is 0.59:0.41. When the adjustment sound signal n is distributed to the channel FL and the channel FR at the distribution ratio, the adjustment sound signal n is localized in the same direction as the arrival direction of the indirect sound 920. As described above, since the adjustment sound signal n has the same feature amount (the delay amount and the level) as the indirect sound 920, the adjustment sound signal n is localized at the same position as the indirect sound 920 by the same size.

Each of the synthesizing unit 4FL and the synthesizing unit 4FR reverses the phase of the distributed adjustment sound signal, and synthesizes the distributed adjustment sound signal having the reversed phase with the audio signals of the channel FL and the channel FR which are input to the adjustment unit 10. Therefore, each of the speaker device 400FL and the speaker device 400FR generates the sound source of an adjustment sound having the reversed phase of the indirect sound 920 in the same position as the sound source position of the indirect sound 920. Then, the indirect sound 920 is offset by the sound source of the adjustment sound having the reversed phase, and thus may be hardly perceptible to a listener.

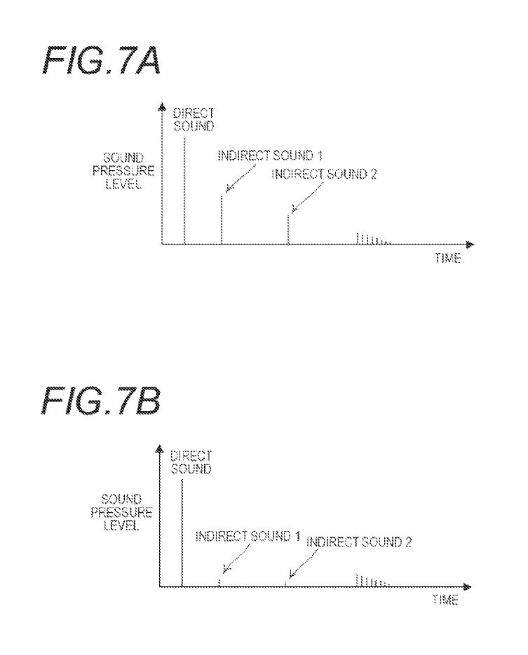

FIG. 7A is a schematic graph illustrating impulse responses in the listening position before an adjustment sound is added and FIG. 7B is a schematic graph illustrating the impulse responses in the listening position after the adjustment sound is added. As illustrated in FIG. 7A, when the adjustment sound is not added, an indirect sound 1 and an indirect sound 2 are sequentially generated after a direct sound is generated. However, in the example, two adjustment sounds are added to the content sound in order to cancel the respective indirect sounds, and thus it is possible to decrease the levels of the respective indirect sounds so that the listener does not feel the indirect sounds as illustrated in FIG. 7B.

The AV receiver 100 is not limited to generate an adjustment sound at the same level as an indirect sound, but may generate an adjustment sound at a different level from an indirect sound by adjusting the gain of the level adjustment unit 21 of each of the taps 2. Therefore, an indirect sound is strengthened or weakened according to the adjustment sound.

Meanwhile, in the above example, adjustment sounds are output from the speaker devices 400 which are disposed across the arrival directions of indirect sounds and are adjacent to each other. However, for example, in the example illustrated in FIG. 6, the adjustment sounds may be output from the speaker device 400C and the speaker device 400FL. In this case, the respective gains of the level adjustment unit 3C and the level adjustment unit 3FL are set according to the orientations of the speaker device 400C and the speaker device 400FL centering on the listening position G and the arrival direction of the indirect sound 920.

In addition, the adjustment unit 10 may generate an adjustment sound only for an indirect sound of which a delay time is shorter than a prescribed time (for example, for one second) relative to the direct sound. Further, the adjustment unit 10 may generate an adjustment sound only for an indirect sound at a level which is equal to or higher than a prescribed level (for example, 0.3 for the direct sound) relative to the direct sound. The adjustment unit 10 can prevent the total processing amounts of the CPU 103 and the DSP 102 from increasing by suppressing the number of adjustment sounds to be generated.

Meanwhile, the function of the level adjustment unit 21 of each of the taps 2 may be realized in the distribution unit 3. That is, a value which is synthesized with the gain of the level adjustment unit 21 may be set to each of the gains of the level adjustment unit 3FL, the level adjustment unit 3FR, the level adjustment unit 3C, the level adjustment unit 3SL and the level adjustment unit 3SR of the distribution unit 3. Therefore, the configuration of the adjustment unit 10 is simplified.

In addition, the adjustment unit 10 may fix the delay amount and the level of each adjustment sound regardless of the delay time and the level of each indirect sound. Further, the adjustment unit 10 may take only the arrival direction of each indirect sound into consideration and may distribute the adjustment sound to the content sound at a distribution ratio based on the arrival direction.

In addition, the measurement unit 11 may simultaneously output measure-test sounds from all the speaker devices 400 with regard to all the channels, and may simultaneously measure a plurality of indirect sounds. In this case, the adjustment unit 10 generates adjustment sounds from a monaural signal in which the audio signals of the respective channels are mixed down.

In addition, the measurement unit 11 is not limited to the example in which indirect sounds are measured by the microphones 300, and may simulate the positions and levels of the indirect sounds from the shape of a room. For example, the audio system according to the embodiment causes a listener to input information, such as the shape of the room and the positions of the speaker devices 400, to a Personal Computer (PC), and calculates the arrival directions, the delay times, and the levels of a plurality of indirect sounds based on the input information through simulation.

In the above-described example, an adjustment sound is generated and the adjustment sound is added to the content sound at the distribution ratio based on the arrival direction of the indirect sound in order to cancel an indirect sound. However, the adjustment unit 10 may move the sound source position of an indirect sound by generating an adjustment sound as below.

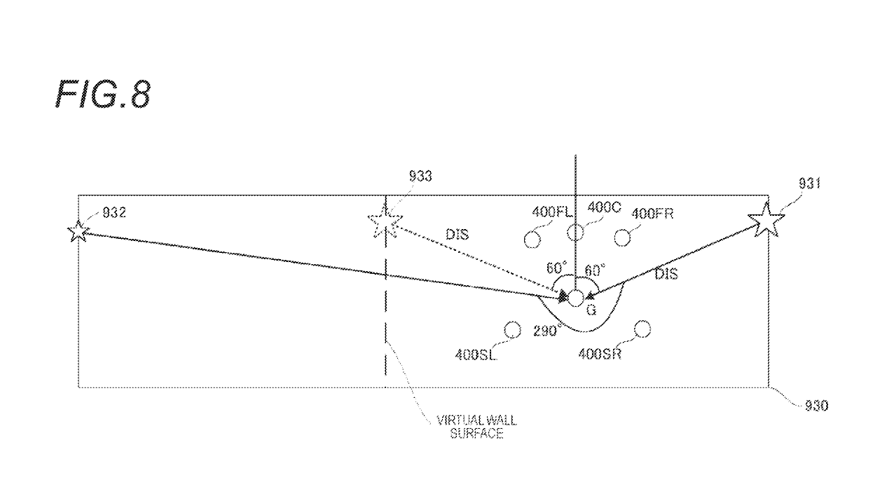

FIG. 8 is a plan schematic diagram illustrating the listening environment in order to describe an example in which the sound source position of an indirect sound is moved using an adjustment sound.

As illustrated in the schematic diagram of FIG. 8, an indirect sound 931 and an indirect sound 932 are generated in a listening environment 930. The indirect sound 931 arrives from an orientation of 60°, and the indirect sound 932 arrives from an orientation of 290°. The indirect sound 932 has a sound source position, which is far from the listening position G, and the level thereof is low compared to the indirect sound 931. That is, the indirect sound 931 and the indirect sound 932 do not have uniform arrival directions, delay times, and levels on a vertical plane which passes through the listening position G along an orientation of 0°.

Here, the adjustment unit 10 adjusts the sound source position of the indirect sound 932 to an orientation of 300°, that is, to a position separated by a distance DIS, which is the same as a distance DIS from the listening position G to the indirect sound 931. Further, the adjustment unit 10 adjusts the level of the indirect sound 932 to the same amplitude of the level of the indirect sound 931.

More specifically, the adjustment unit 10 generates an adjustment sound signal in order to cancel the indirect sound 932 at the first stage tap 2 of the multi-tap delay 1 in the same manner as the above-described example. Further, the adjustment unit 10 generates an adjustment sound signal, which has the same feature amount (the delay time and the level) as the indirect sound 931, in the second stage tap 2. Further, in the distribution unit 3 corresponding to the adjustment sound signal, which is output from the second stage tap 2, the gains of the level adjustment unit 3FL and the level adjustment unit 3SL are set such that the adjustment sound signal is localized at an orientation of 300°. Then, the indirect sound 932 moves to a position, which forms a mirror image of the indirect sound 931, on the vertical plane along an orientation of 0° centering on the listening position G. That is, the indirect sounds 931 and 933 are symmetric about the listening position G. Therefore, a listener perceives that the indirect sound 933 exists on a virtual wall surface illustrated in FIG. 8.

As described above, since distances from the listening position G to the right and left (orientations of 90° and 270°) walls are not uniform, the AV receiver 100 adjusts the position of the indirect sound 932 even when the respective arrival directions of the right and left indirect sounds are not symmetric to each other, and thus it is possible to allow the listener to feel that the listener is present in a space in which the distances from the listening position G to the right and left walls are uniform.

Meanwhile, the audio system according to the embodiment may adjust only the arrival direction of an indirect sound or only the delay time of an indirect sound.

In addition, the audio system according to the embodiment can increase the sound image of an indirect sound by generating the sound source of an adjustment sound, which has the same component as the indirect sound, in a vicinity of the sound source position of the indirect sound.

In addition, the audio system according to the embodiment may cause the listener to perform an indirect sound adjustment operation using, for example, a PC. Further, the audio system causes the PC to display the display content illustrated in FIG. 4, and receives input, such as an indirect sound cancellation operation, an indirect sound level adjustment operation, and an indirect sound movement operation, using the input device (keyboard or the like) of the PC. Further, the AV receiver 100 generates an adjustment sound based on operation input information.

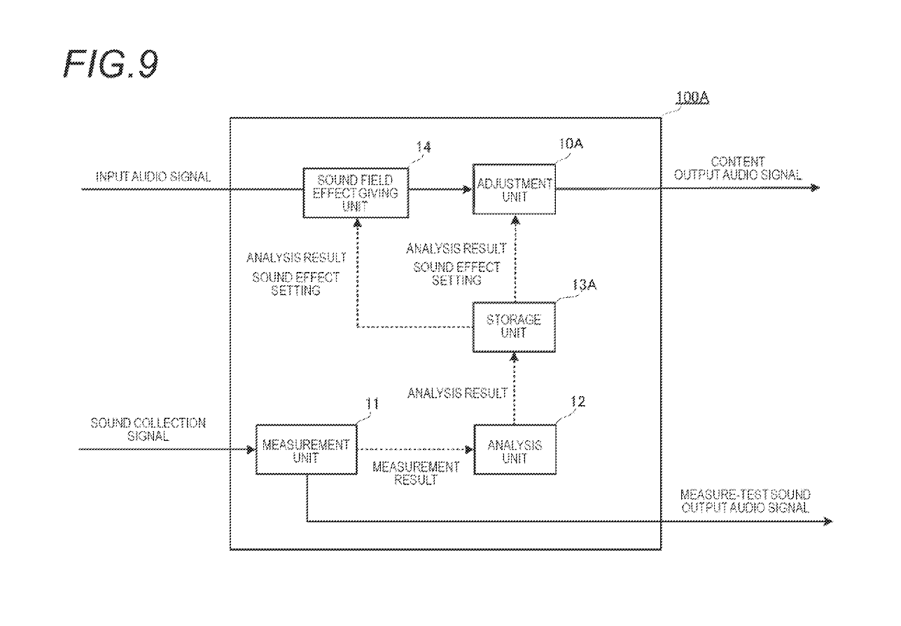

Subsequently, an audio system according to a second embodiment will be described with reference to FIG. 9. FIG. 9 is a block diagram illustrating the function of an AV receiver 100A.

The AV receiver 100A is different from the AV receiver 100 in that the AV receiver 100A includes an adjustment unit 10A, a storage unit 13A, and a sound field effect giving unit 14. That is, the AV receiver 100A generates a desired sound field by adjusting indirect sounds using adjustment sounds while adding simulated reflection sounds, acquired by simulating the reflection sounds of a concert hall or the like, to a content sound.

An audio signal, which is input to the AV receiver 100A, is input to the sound field effect giving unit 14. However, the audio signal may be input to the sound field effect giving unit 14 at the rear stage of the adjustment unit 10A. Meanwhile, the function of the sound field effect giving it 14 is realized by the DSP 102.

The sound field effect giving unit 14 generates simulated reflection sounds based on the input audio signal of a center channel. More specifically, the sound field effect giving unit 14 reads setting information about each of the simulated reflection sounds to be generated from the storage unit 13A. The setting information about each of the simulated reflection sounds includes information indicative of each of a distance from the listening position G, an arrival direction to the listening position G, and a level. The sound field effect giving unit 14 delays the audio signal by the delay amount according to the distance of each of the simulated reflection sounds, and adjusts the level based on the level included in the setting information. The sound field effect giving unit 14 adjusts the level, and distributes the delayed audio signal to the audio signal of each channel at a gain ratio according to the arrival direction of each of the simulated reflection sounds. For example, the sound field effect giving unit 14 distributes the audio signal to the channel FL and the channel SL at a gain ratio of 1:1. Then, the sound source of each of the simulated reflection sounds is generated in a position which is separated by a prescribed distance from the listening position G which passes through the center position of the speaker device 400FL (arranged at an orientation of 330°) and the speaker device 400SL (arranged at an orientation of 240°) at an orientation of 235°.

Meanwhile, it is possible to change the setting information about each of the simulated reflection sounds by the listener. In addition, the sound field effect giving unit 14 is not limited to the center channel, and may generate the simulated reflection sounds from a monaural signal in which the audio signals of multiple channels are mixed down.

The audio signal, which is output from the sound field effect giving unit 14, is input to the adjustment unit 10A.

Here, the sound field effect giving unit 14 reads analysis result information from the storage unit 13A, and adjusts the level of each of the simulated reflection sounds based on the level of each of the indirect sounds which arrive at the listening position G. In addition, the adjustment unit 10A reads the setting information about each of the simulated reflection sounds from the storage unit 13A, and determines indirect sounds for which adjustment sounds should be generated.

More specifically with regard to each of the simulated reflection sounds, when the arrival direction of the simulated reflection sound. coincides with any one of the arrival directions of the indirect sounds and the distance of an indirect sound having an arrival direction, which coincides with the arrival direction of the simulated reflection sound, from the listening position G coincides with the distance of the simulated reflection sound from the listening position G, the sound field effect giving unit 14 attenuates the level of the simulated reflection sound based on the level of the indirect sound. That is, when the sound source position of the simulated reflection sound coincides with any one of the sound source positions of the indirect sounds, the sound field effect giving unit 14 attenuates the level of the simulated reflection sound such that the sound pressure of the simulated reflection sound does not increase due to the indirect sound in the listening position G. For example, when the level of the simulated reflection sound is 5 dB and the level of the indirect sound in a position, which is the same as the sound source position of the simulated reflection sound, is 2 dB, the sound field effect giving unit 14 sets the level of the simulated reflection sound to 3 dB. In addition, the adjustment unit 10A does not generate an adjustment sound for an indirect sound generated in a position which is the same as the sound source position of the simulated reflection sound which has the attenuated level, and generates an adjustment sound for only another indirect sound.

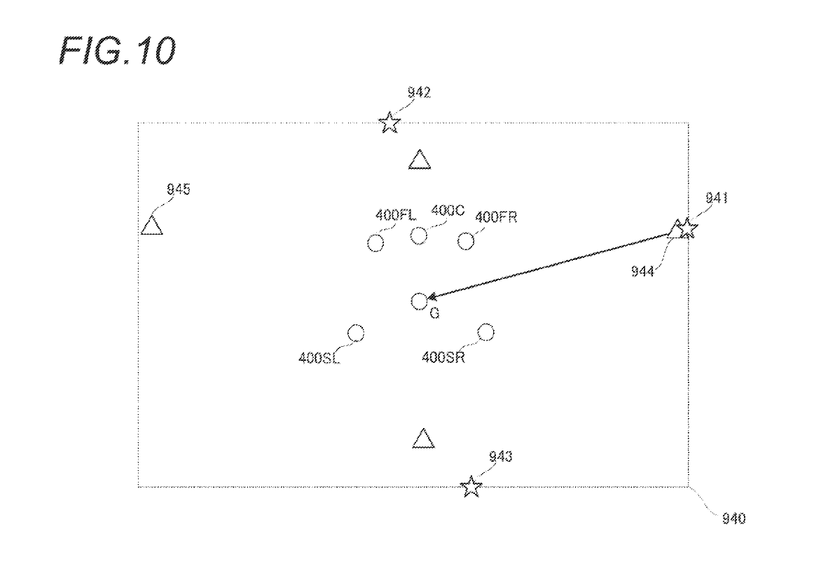

FIG. 10 is a plan schematic diagram illustrating a listening environment in order to describe an example in which the level of the simulated reflection sound is attenuated according to the sound source position of the indirect sound. In the drawing, a star indicates the sound source of the indirect sound, and a triangle indicates the sound source of the simulated reflection sound.

As illustrated in FIG. 10, in the listening environment 940, the distance and the arrival direction of a simulated reflection sound 944 are set such that the simulated reflection sound 944 is generated in the position of an indirect sound 941. In the listening position G, it is assumed that the listener listens to the indirect sound 944 and the simulated reflection sound 941 at the same timing and from the same direction. Here, the AV receiver 100A attenuates the level of the simulated reflection sound 941, prevents a sound pressure from increasing due to the indirect sound 944 in the listening position G, and thus it is possible to give a desired sound field effect to the content sound.

Meanwhile, with regard to an indirect sound 942 and an indirect sound 943 in positions which are different from the sound source position of the simulated reflection sound, the AV receiver 100A does not offset the level of the simulated reflection sound and cancels the generation of an adjustment sound with regard to the indirect sound 942 and the indirect sound 943.

What is claimed is:

1. An audio processing apparatus comprising:
a measuring unit adapted to output a measure-test sound from a plurality of speaker devices and measure an arriving direction of an indirect sound for the output measure-test sound;
a generator adapted to generate an adjustment sound for adjusting the indirect sound; and
an adjustment sound adder adapted to add the adjustment sound into a sound to be output from at least one of the plurality of speaker devices by a distribution ratio which is set based on the arriving direction of the indirect sound.

2. The audio processing apparatus according to claim 1, wherein
the measuring unit is adapted to measure a delay time and a level of the indirect sound relative to a direct sound of the measure-test sound, and
the generator is adapted to generate the adjustment sound based on the delay time and the level of the indirect sound measured by the measuring unit.

3. The audio processing apparatus according to claim 2, wherein the generator is adapted to generate the adjustment sound including a sound having a reversed phase of the indirect sound.

4. The audio processing apparatus according to claim 3, wherein,
where the indirect sound is referred to as a first indirect sound, and the adjustment sound is referred to as a first adjustment sound,
the generator is further adapted to generate a second adjustment sound that is different from the first adjustment sound, and
the adjustment sound adder is further adapted to add the second adjustment sound into the sound to be output from at least one of the plurality of speaker devices so that the sound added with the first and second adjustment sounds is localized at a different orientation from the arriving direction of the first indirect sound.

5. The audio processing apparatus according to claim 4, wherein
the measuring unit is further adapted to measure an arriving direction of a second indirect sound for the output measure-test sound,
the generator is adapted to generate the second adjustment sound having a delay time and a level same as those of the second indirect sound, and
the adjustment sound adder is adapted to add the second adjustment sound into the sound to be output from at least one of the plurality of speaker devices so that the sound added with the first and second adjustment sounds is localized at an symmetric orientation to the arriving direction of the second indirect sound about a listening position.

6. The audio processing apparatus according to claim 2, further comprising:
a sound field effect giving unit adapted to give a simulated reflection sound into the sound to be output from at least one of the plurality of speaker devices to apply a sound field effect, wherein
the sound field effect giving unit is adapted to attenuate a level of the simulated reflection sound based on the level of the indirect sound when a sound source position of the simulated reflection sound coincides with any one of sound source positions of indirect sounds for the measure-test sound.

7. The audio processing apparatus according to claim 2, wherein the generator is adapted to generate the adjustment sound only for the indirect sound of which the delay time is shorter than a prescribed time relative to the direct sound.

8. The audio processing apparatus according to claim 2, wherein the generator is adapted to generate the adjustment sound only for the indirect sound of which the level is equal to or higher than a prescribed level relative to the direct sound.

9. The audio processing apparatus according to claim 1, wherein the generator includes a multi-tap delay.

10. An audio processing method comprising:
outputting a measure-test sound from a plurality of speaker devices;
measuring an arriving direction of an indirect sound for the output measure-test sound;
generating an adjustment sound for adjusting the indirect sound; and
adding the adjustment sound into a sound to be output from at least one of the plurality of speaker devices by a distribution ratio which is set based on the arriving direction of the indirect sound.
